(19) United States
(12) Patent Application Publication
(10) Pub. No.: US 2017/0178137 A1
(43) Pub. Date: Jun. 22, 2017

(54) PARAMETER-MAPPED ONE-TIME PASSWORDS (OTP) FOR AUTHENTICATION AND AUTHORIZATION

(71) Applicant: CA, Inc., New York, NY (US)

(72) Inventors: Rajendra Kumar Pachouri, Bangalore (IN); Sharath Lakshman Kumar, Bangalore (IN); Mohammed Mujeeb Kaladgi, Bangalore (IN)

(73) Assignee: CA, Inc., New York, NY (US)

(21) Appl. No.: 14/973,003

(22) Filed: Dec. 17, 2015

(51) Int. Cl. G06Q 20/40; G06Q 20/34; H04L 29/06

(52) U.S. Cl. CPC G06Q 20/4014; H04L 63/0838; H04L 63/102; G06Q 20/34

(57) ABSTRACT

A message, which includes a user-defined transaction parameter for a transaction with a terminal that is communicatively coupled to a node of a secure authorization network, is received by a computer server via a network node that is outside of the secure authorization network. An authorization request message for the transaction with the terminal is received by the computer server via the secure authorization network. The authorization request message includes a one-time password that is provided by the terminal. Authentication is performed by the computer server based on the one-time password, and the user-defined transaction parameter for the transaction with the terminal is identified by the computer server based on the one-time password included in the authorization request message. An authorization response message for the transaction with the terminal based on the user-defined transaction parameter is transmitted from the computer server via the secure authorization network.

### FIELD

The present invention relates generally to electrical computers and digital processing systems, and more particularly, to interprogram communication for authentication and authorization.

### BACKGROUND

There are many systems that rely on PINs (personal identification numbers) to authenticate a user for electronic transaction. Some examples of such systems include card-based or secure element (SE)-based transactions. PIN-based systems are often not used for internet or card not present (CNP) types of transactions, as these types of transactions may be vulnerable to interception, compromise, and/or future fraudulent activity. For example, if an unauthorized user acquires a card number and the corresponding PIN, the unauthorized user can impersonate the card owner in future transactions.

The trust model upon which PIN-based systems are based may be vulnerable because parties that accept PINs typically trust the PIN verification completely, by choice or by requirement. As the PIN may be static (i.e., the same PIN may be used in every transaction), the PIN may be susceptible to being stolen. Also, compromise of any a single PIN-accepting device may result in potential fraud against the system. For example, once in possession of the PIN, an unauthorized user controls the amount that will be charged. Although some advances have been made to PIN-based systems, these systems continue to fall short.

### SUMMARY

Some embodiments described herein are directed to a computer server that is communicatively coupled to one of a plurality of nodes of a secure authorization network. The computer server includes a network interface, a processor coupled to the network interface, and a memory coupled to the processor. The memory includes a computer-readable storage medium storing computer-readable program code therein. When executed, the computer-readable program code causes the following operations to be performed by the processor of the computer server. A message, which includes a user-defined transaction parameter for a transaction with a terminal that is communicatively coupled to a node of the secure authorization network, is received through the network interface via a network node that is outside of the secure authorization network. An authorization request message for the transaction with the terminal is received through the network interface via the secure authorization network. The authorization request message includes a one-time password that is provided by the terminal. Authentication is performed based on the one-time password, and the user-defined transaction parameter for the transaction with the terminal is identified by the computer server based on the one-time password included in the authorization request message. An authorization response message for the transaction with the terminal based on the user-defined transaction parameter is transmitted through the network interface via the secure authorization network. The authorization response message may be based on the user-defined transaction parameter independent of an indication of a conflicting parameter for the transaction by the terminal.

Some embodiments described herein are directed to a method, in which operations as follow are performed by a processor of a computer server that is communicatively coupled to one of a plurality of payment nodes of a secure payments network. In the method, a message, which includes a consumer-defined transaction amount for an electronic transaction with a merchant terminal that is communicatively coupled to one of the payment nodes, is received by the computer server via a network node that is outside of the payments network. An authorization request message for the electronic transaction with the merchant terminal is received by the computer server via the payments network, where the authorization request message includes a one-time password that is provided by the merchant terminal. Authentication is performed by the computer server based on the one-time password, and the consumer-defined transaction amount for the electronic transaction with the merchant terminal is identified by the computer server based on the one-time password included in the authorization request message. An authorization response message for the electronic transaction with the merchant terminal based on the consumer-defined transaction amount is transmitted from the computer server via the payments network. The authorization response message may be based on the consumer-defined transaction amount independent of an indication of a monetary amount for the transaction by the merchant terminal.

Some embodiments described herein are directed to a computer program product including a computer-readable storage medium having computer-readable program code embodied therein. When executed, the computer-readable program code causes the following operations to be performed by a processor of a computer server. A message, which includes a consumer-defined transaction amount for an electronic transaction with a merchant terminal that is communicatively coupled to one of a plurality of payment nodes of a secure payments network, is received by the computer server via a network node that is outside of the payments network. An authorization request message for the electronic transaction with the merchant terminal is received by the computer server via the payments network. The authorization request message includes a one-time password that is provided by the merchant terminal. Authentication is performed by the computer server based on the one-time password, and the consumer-defined transaction amount for the electronic transaction with the merchant terminal is identified by the computer server based on the one-time password included in the authorization request message. An authorization response message for the electronic transaction with the merchant terminal, based on the consumer-defined transaction amount, is transmitted from the computer server via the payments network. The authorization response message may be based on the consumer-defined transaction amount independent of an indication of a monetary amount for the transaction by the merchant terminal.

Other methods, computer servers, network nodes, and computer program products according to embodiments will be or become apparent to one with skill in the art upon review of the following drawings and detailed description. It is intended that all such additional methods, computer servers, network nodes, and computer program products, including any and all combinations of operations performed thereby, be included within this description and protected by the accompanying claims.

### BRIEF DESCRIPTION OF THE DRAWINGS

Aspects of the present disclosure are illustrated by way of example and are not limited by the accompanying drawings. In the drawings:

FIG. 1A is a block diagram illustrating components of a computer system in accordance with some embodiments.

FIGS. 1B and 1C are flow diagrams illustrating operations performed by various components of the computer system of FIG. 1A in accordance with some embodiments.

FIGS. 2-5 are flowcharts illustrating operations performed by various components of a computer system in accordance with some embodiments.

FIG. 6 is a block diagram of a computer system that may be incorporated into various components of the computer system of FIG. 1A in accordance with some embodiments.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

As described herein, a computer server may include a computer or cluster of computers. For example, the computer server can be a large mainframe, a minicomputer cluster, or a group of servers functioning as a unit. In one example, the computer server may be coupled to a Web server. The computer server may be coupled to a database and may include hardware (including one or more processors, memory, etc.), software, or combinations thereof for servicing the requests from one or more client computers. The computer server may include one or more computational apparatuses and may use any of a variety of computing structures, arrangements, and compilations for servicing the requests from one or more client computers.

An issuer may refer to a business entity (e.g., a bank) that maintains an account (e.g., a monetary account, such as a bank account, payment account, etc.) for a consumer (also referred to herein as an account holder). The account may be associated with a portable payments device. A portable payments device may refer to a mobile communication device, such as a smartphone, tablet computer, or other consumer electronic device including a mobile payments application installed thereon, or may refer to a credit card, debit card, smart card, or other portable card. An issuer may also store and/or define account parameters associated with the account for use by the payments device. An issuer may be associated with an issuer computer server that performs some or all of the functions of the issuer, and/or an authorization computer server that performs at least some functions on behalf of the issuer.

A merchant may refer to an entity that engages in electronic transactions for goods or services. A merchant terminal may refer to a computer include a point-of-sale (POS) terminal, a point-of-banking (POB) terminal, an automated teller machine (ATM) terminal, and/or other terminal that is associated with the merchant and is operable to conduct a monetary transaction with a user/consumer account.

An acquirer may refer to a business entity (e.g., a commercial bank) that has a business relationship with a merchant or other entity. An acquirer may be associated with an acquirer computer server that performs some or all of the functions of the acquirer. In some embodiments, an acquirer may include one or more entities that can perform some issuer and acquirer functions.

Some embodiments described herein provide methods, devices, and systems for network-based electronic transactions that can be performed by a payments device with or without a hardware-based secure element. For example, EMV cards (which are smart cards which store data on integrated circuits rather than magnetic stripes) may be used for contactless payment when a physical card is present; however, some embodiments described herein can utilize card emulation technology (e.g., Host Card Emulation (HCE), etc.) to emulate a smartcard on a mobile communication device (e.g., a portable payments device) to allow a client application running on the payments device to conduct contactless transactions, where the EMV application can be stored on a cloud-based Secure Element (SE). In particular, a client application can access a contactless interface (e.g., a near-field communication (NFC) transceiver) of the payments device via the operating system (OS) of the payments device without involving a hardware-based secure element. For example, when a user presents a cloud-based card for transaction, NFC commands may be routed to an HCE client app for verification and authorization processing though a mobile application management platform (MAP). The MAP in turn may connect to the issuer backend and payment system as needed to complete the transaction. The system may also include a cloud server managing the issuance of card data and cloud account lifecycle and a cloud transaction processor. A trusted tokenization system may be a shared resource that can be used to generate and de-tokenize tokens representing actual card data in the issuer backend. However, other embodiments described herein can be utilized with a contact-based or contactless smart card or fob that includes a hardware-based secure element therein. Still other embodiments described herein can be utilized with a credit/debit card that does not include a secure element therein, for example, a magnetic stripe-based card.

Embodiments described herein may arise from realization that, in some PIN-based systems for conducting electronic transactions, the merchant specifies the amount that will be charged to a consumer's account. For example, when conducting a credit/debit card transaction with a local or online merchant, the consumer does not have control on how much money will be charged to or debited from the card, which may result in unauthorized charges if the card number and PIN are compromised. Accordingly, embodiments of the present invention enable electronic transactions with a merchant via a secure payments network, subject to a consumer-defined transaction amount (and/or other consumer-defined transaction parameters) that is received via a network node that is outside of (e.g., not authorized for access or communication with) the secure payments network.

In some embodiments, the consumer-defined transaction amount (and/or other transaction parameters) can be determined from or is otherwise associated with a one-time password (OTP). In particular, OTP generation can be initiated by the consumer/account holder via a network node that is outside of the secure payments network, using a client application or web portal executing on a consumer electronic device, prior to initiating a transaction with a merchant terminal. For example, the consumer/account holder may specify transaction details including a monetary amount, particular location(s), particular merchant(s), duration/times of use, and/or other transaction parameters via the client application or web portal, and the account issuer (or associated third-party server) may generate an OTP that is associated with those specific transaction details that were defined by the consumer/account holder. The OTP may be transmitted to the consumer/account holder (or to another party whom the consumer/account holder has authorized for use of his account) via the client application or web portal or e-mail, thereby avoiding network-based delivery costs (e.g., SMS messaging charges). Upon subsequent receipt of the OTP from a merchant terminal, the issuer/associated third-party server may authorize the transaction with the merchant terminal for only the exact transaction amount (and/or other transaction parameters) specified by the consumer. As such, the merchant terminal may have no control over the amount of transaction, but rather, may be approved to conduct the electronic transaction subject to the consumer-defined transaction amount from the OTP.

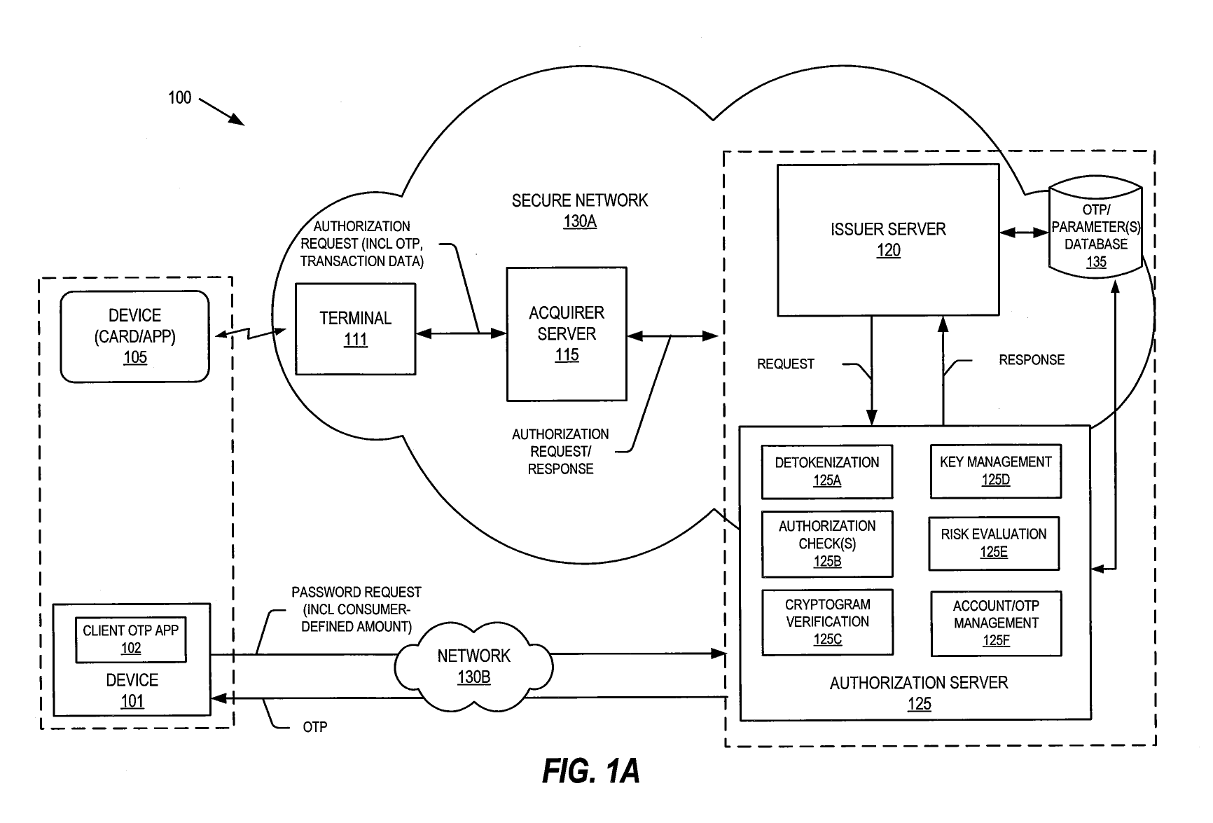

FIG. 1A is a block diagram illustrating components of a computer system or environment 100 in accordance with some embodiments. Referring now to FIG. 1A, the computer system 100 includes a merchant terminal 111, an acquirer server 115 (which may be associated with the merchant's bank), an issuer server 120 (which may be associated with the account holder's bank), an authorization server 125, and an OTP/amount or parameters database 135, all of which are communicatively coupled to payment nodes that define a secure payments network (referred to herein as payments network/nodes 130A). The authorization server 125 may be configured to perform various functions for the issuer server 120, including but not limited to detokenization 125A, authorization check(s) 125B, cryptogram verification 125C, key management 125D, risk evaluation 125E, and account/OTP management 125F. In some embodiments, the authorization server 125 may be a third-party server that is communicatively coupled to the issuer server 120 and is configured to perform various functions on behalf of the issuer server 120.

At least one of the issuer server 120 and the authorization server 125 is communicatively coupled, via one or more network nodes 130B that are outside of the secure payments network 130A, to a consumer device 101. The consumer device 101 may be any wired or wireless consumer electronic device that is configured to transmit and receive data or communications to and from the servers 120 and/or 125 outside of the secure payments network 130A. For example, the consumer device 101 may be configured to store and execute a client application 102 that is provided by the issuer server 120 and/or authorization server 125 for password generation and/or payment, and may include one or more network transceivers configured for communication with the server(s) 120/125 via the network/nodes 130B outside of the secure payments network/nodes 130A. A user or consumer operating the consumer device 101 may be an account holder of an account that was issued by the issuer server 120. The account may be associated with a portable payments device 105 (such as a credit card or a mobile communications device executing a payment application).

It will be appreciated that, in various embodiments described herein, the consumer device 101 and the payments device 105 may be implemented in a single device, while in other embodiments, the consumer device 101 and the payments device 105 may be separate devices. For example, the consumer device 101 may be a mobile phone (e.g., smart phone, cellular phone, etc.), tablet, portable media player, laptop computer, desktop computer, personal digital assistant (PDA), and/or wearable computing device (e.g., watch), or other consumer electronic device. The payments device 105 may be any device that can be transported and operated by a user to conduct a transaction with the merchant terminal 111, for example, a mobile phone, tablet, portable media player, laptop computer, personal digital assistant (PDA), wearable computing device, other consumer electronic device that is configured to execute a payments application associated with the consumer account, or a pocket-sized or other portable card (e.g., contact-based or contactless smart credit/debit card) or fob that is associated with the consumer account, and is also referred to herein as a portable payments device.

It will likewise be appreciated that, in various embodiments described herein, the issuer server 120 and authorization server 125 may be implemented as a single server, separate servers, or a network of servers (physical and/or virtual), which may be co-located in a server farm or located in different geographic regions. Various nodes of the network 130B may be part of a local, wide area, or global network, such as the Internet or other publicly accessible network, which are not authorized to access (e.g., outside of) the secure payments network 130A. Various elements of the secure payments network/nodes 130A may be interconnected by a secure wide area network (WAN), local area network (LAN), Intranet, and/or other private network, which may not be accessible by the nodes of the network 130B. The networks 130A and 130B may include wireless and/or wireline networks. More generally, although FIG. 1A illustrates an example of a computing system or environment 100, it will be understood that embodiments described herein are not limited to such a specific configuration, but are intended to encompass any configuration capable of carrying out the operations described herein.

FIG. 1B is a flow diagram illustrating operations performed in requesting, generating, and receiving a one-time password (OTP) by various components of the computer system 100 of FIG. 1A in accordance with some embodiments prior to a initiating or completing an electronic transaction with a merchant. As shown in FIG. 1B, the consumer device 101 receives selection of an account for an electronic transaction with a merchant terminal from a user (e.g., the account holder) of the consumer device 101 via its user interface. In response, the consumer device 101 generates and transmits a request message containing an account identifier (illustrated with reference to a card number or identifier) for the selected account, via the network/node 130B outside of the payments network 130A, to the issuer server 120 or the authorization server 125 (hereinafter referred to as the server 120/125). Similarly, the consumer device 101 receives selection of a monetary amount (and/or other parameters) for the transaction from the user via its user interface, and generates and transmits a request message containing the consumer-defined amount (and/or other consumer-defined parameters) for the transaction, via the network/node 130B outside of the payments network 130A, to the server 120/125. The account identifier and consumer-defined transaction parameter(s) may be included in a single request message from the consumer device 101 in some embodiments. In some embodiments, in addition to a monetary amount, the consumer-defined transaction parameters can specify transaction details including particular location(s), particular merchant(s), duration/times of use, and/or other consumer-defined parameters.

In response to receiving the request message(s) including the card number (or other account identifier) and consumer-defined amount (and/or other consumer-defined parameters) for the transaction via the network/node 130B outside of the payments network 130A, the server 120/125 generates a one-time password or PIN (OTP). The OTP is associated with the consumer-defined amount (and/or other consumer-defined parameters) for the transaction, for example, by generating and storing a data structure indicative of the association in the OTP/amount database 135. The server 120/125 also marks the card number (or other account identifier) for authentication using the generated OTP as a secondary password or PIN, in addition to or instead of authentication using any password or PIN that was previously-associated with the account (referred to hereinafter as a primary password or PIN). As such, responsive to generation of the OTP, the account corresponding to the card number (or other account identifier) can be authenticated using the OTP in lieu of the primary password, allowing the user to maintain the primary password in confidence. In some embodiments, the OTP may be one of multiple secondary passwords associated with the account, where each of the secondary passwords is generated by the server 120/125 and associated with a respective consumer-defined transaction amount by a respective data structure stored in the OTP/amount database 135.

Still referring to FIG. 1B, the server 120/125 transmits a response message containing the OTP back to the consumer device 101 (or other device specified by the user of the consumer device 101) via the network/node 130B outside of the payments network 130A. In some embodiments, the response message containing the OTP may be provided to the consumer device 101 (or other specified device) via a client application program 102 executing thereon, rather than via SMS-based delivery (thereby avoiding delivery costs may be incurred with SMS). The consumer device 101 (or other device specified by the user of the consumer device 101) may display the OTP, via its user interface, for a future transaction that is subject to the consumer-defined transaction parameter(s) associated with the OTP. Thus, the user of the consumer device 101 (for example, the account holder) can pre-set one or more transaction details in advance of an electronic transaction with a merchant terminal, by controlling initiation of the process by which the OTP is generated.

In some embodiments, the consumer device 101 may be a smartphone or other mobile communication device that executes a client application program 102 for communication with the server 120/125. For example, a bank card user may log into his bank application on the consumer device 101, and may select a “Generate One Time Card PIN” link displayed by the user interface of the consumer device 101. Responsive to the selection, the user interface may display a drop down menu that allows selection of the card number associated with the account for which the OTP is desired. The user may thereby select one of his cards/accounts via the user interface of the consumer device 101, and the user interface may display a prompt to enter the amount for which an OTP is desired. The user may enter a consumer-defined amount (e.g., $20), and may select the “Submit” link displayed by the user interface. In response to receiving a selection of the consumer-defined amount, the consumer device 101 may generate and transmit a password request message to the server 120/125, which may generate an OTP associated with the consumer-defined amount and transmit a password response message containing the OTP back to the consumer device 101. The user interface of the consumer device 101 may thus display the OTP (for example, a 6 digit number). The OTP can be used in a merchant terminal (such as an ATM or POS), as described in detail below with reference to FIG. 1C.

FIG. 1C is a flow diagram illustrating operations performed in initiating and conducting an electronic transaction using the one-time password (OTP) generated in FIG. 1B by various components of the computer network of FIG. 1A in accordance with some embodiments. As shown in FIG. 1C, in initiating an electronic transaction, a user provides, via a payments device 105, a card number (or other account identifier) associated with a selected account to a merchant terminal 111. For instance, the payments device 105 may be a ‘smart’ or EMV-compliant credit/debit card including an integrated circuit chip therein, which provides the card number to the merchant terminal 111 via a contact-based or contactless payment method (for example, by including the card number in a message transmitted via radio-frequency identification or near field communication). Alternatively, the payments device 105 may be a mobile device executing a client payments application, which wirelessly transmits a message containing the card number (or other account identifier) to the merchant terminal 111. The user also provides the OTP associated with the consumer-defined transaction parameter(s), which was generated in FIG. 1B, to the merchant terminal 111. For instance, in some embodiments, the user may physically enter the OTP on a keypad or other user interface associated with the merchant terminal 111. Additionally or alternatively, the OTP may be included in a message (for example, in a transaction cryptogram) that is wirelessly transmitted from the payments device 105 to the merchant terminal 111.

In response, the merchant terminal 111 generates an authorization request message including the OTP and the account identifier, and transmits the authorization request message to the server 120/125 via the secure payments network/node 130A. The request message transmitted by the merchant terminal 111 may include other transaction data, but may not contain any indication of the monetary amount for the transaction in some embodiments. In response to receiving the authorization request message, the server 120/125 verifies the card number, performs authentication based on the OTP (rather than based on a primary password that is associated with the corresponding account), and identifies the consumer-defined transaction parameter(s) that are associated with the OTP. The server 120/125 further generates an authorization response message for the electronic transaction with the merchant terminal subject to the consumer-defined transaction parameter(s), and transmits the authorization response toward the merchant terminal 111 via the secure payments network/node 130A. For example, the authorization response message may indicate authorization for the electronic transaction for the exact monetary amount that was previously-defined by the consumer device 101 and associated with the OTP by the server 120/125 in the operations of FIG. 1B. Alternatively, the authorization response message may indicate denial of the electronic transaction, for instance, where the merchant terminal 111 specifies a transaction amount that is different from the consumer-defined monetary amount associated with the OTP.

Still referring to FIG. 1C, the server 120/125 may generate and transmit the authorization response message indicating authorization for only the consumer-defined transaction amount, and independent or regardless of any indication of a monetary amount (or other merchant-defined parameter(s)) for the transaction by the merchant terminal 111. For example, the authorization response message may indicate approval of the transaction for the consumer-defined amount associated with the OTP, but may indicate declination of the transaction for a merchant-defined amount that conflicts with the consumer-defined amount. As such, control over the transaction details, and in particular the monetary amount for the electronic transaction, can be controlled by the user/account holder, regardless of input by the merchant terminal 111 and/or the current user of the payments device 105 (who may or may not be the account holder, for example, where the account holder has let another party borrow his card). The merchant terminal 111 thereby indicates acceptance or denial of the electronic transaction to the user of the payments device 105 (for example, via its own user interface or by transmitting a message to the payments device 105 for display thereby).

For example, in some embodiments, the merchant terminal 111 may be an ATM, and the payments device 105 may be bank/ATM card. At the ATM 111, the user may insert the card 105 into the ATM 111, and the ATM 111 may display a prompt asking the user to enter the PIN associated with the card 105. Rather than entering the primary password, however, the user may enter the OTP that was previously provided to the user of the card 105 via a network node 130B that is outside of the secure payments network 130A. In response to receiving the OTP, the ATM 111 may generate and transmit an authorization request message including the OTP and the card identifier to a server 120/125 via the secure payments network/node 130A. The server 120/125 may be associated with the issuer of the card/account, or may be an authorization server that is coupled to the issuer via the secure payments network 130A. The server 120/125, upon performing authentication using the OTP, may identify that the OTP is associated with a consumer-defined amount (e.g., $20 in the example of FIG. 1B), may debit the consumer-defined amount from the account associated with the card 105, and may generate and transmit an authorization response message indicative of the same toward the ATM 111 via the secure payments network/node 130A. The ATM 111 may then output the consumer-defined amount (e.g., $20) to the user of the card 105. As such, the user need not enter the amount for the transaction at the ATM 111, allowing for faster check-out at the ATM 111. In some embodiments, once the OTP is generated, the user may be unable to use the permanent PIN/primary password associated with the card, that is, the server 120/125 may mark the account for authentication using the OTP instead of the primary password. For example, if the user enters the primary password for the card 105 at the ATM 111, the ATM 111 may display an error message, e.g., “incorrect PIN entered.”

As another example, in some embodiments, the merchant terminal 111 may be a merchant POS, and the device 105 may be credit/debit card. At the time of the transaction, the user may hand the card 105 to the merchant, who may swipe the card 105 at the POS 111 to input the card identifier. The user may also physically enter the OTP via a user interface of the POS 111. In response to receiving the OTP, the POS 111 may generate and transmit an authorization request message including the OTP and the card identifier via the secure payments network/node 130A to a server 120/125, which, upon performing authentication using the OTP, may identify that the OTP is associated with a consumer-defined amount (e.g., $20 in the example of FIG. 1B), may charge or debit the consumer-defined amount to or from the account associated with the card 105, and may generate and transmit an authorization response message indicative of the same toward the POS 111 via the secure payments network/node 130A. The POS 111 may provide an indication of success or failure of the electronic transaction to the user of the device 105, for example, via the user interface of the POS 111. As such, in embodiments described herein, the merchant POS 111 lacks any control over the transaction amount., which may be advantageous, for example, where the card 105 is temporarily removed from the user's possession to conduct the transaction with the POS 111 (for example, at a restaurant where the POS 111 has a fixed location that is away from the user). Thus, according to some embodiments described herein, the user has confidence that the merchant cannot enter a transaction amount that differs from the consumer-defined amount.

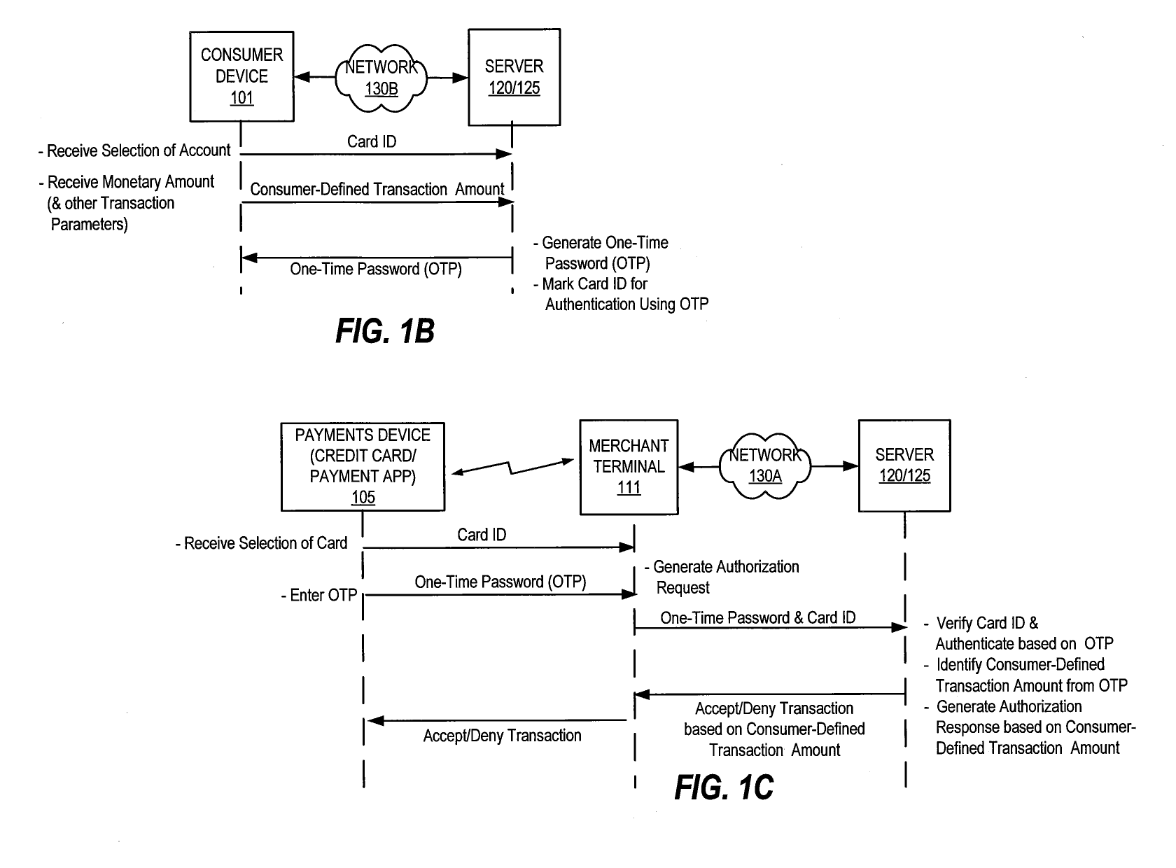

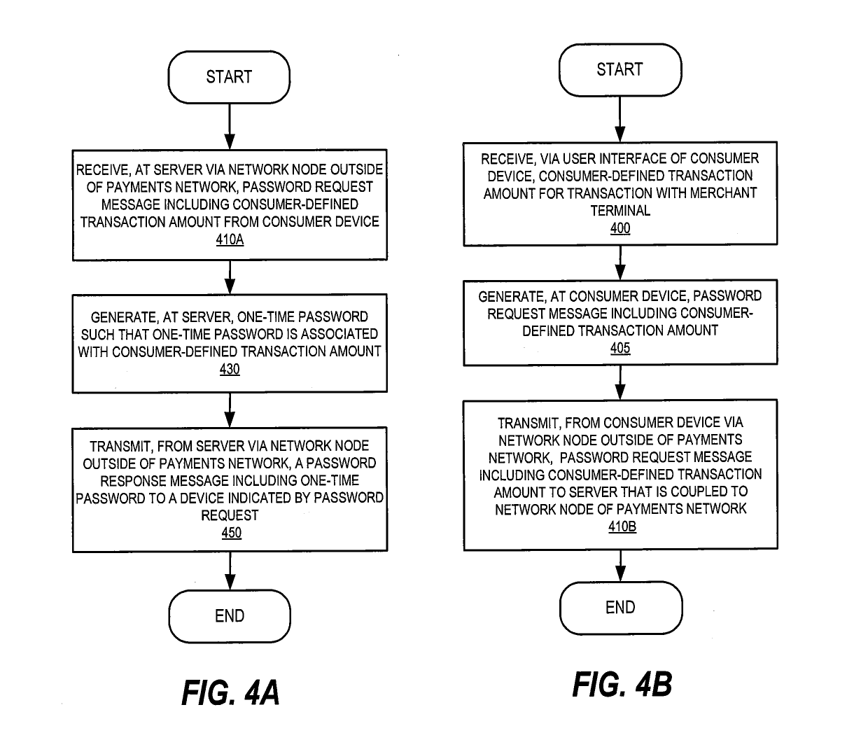

FIGS. 2-5 are flowcharts illustrating operations performed by various components of a computer system in accordance with some embodiments. For example, the operations of FIGS. 2, 3, 4A, and 5 may be performed by a computer server communicatively coupled to a payment node of a secure payments network (for example, the authorization server 125 and/or the issuer server 120 of FIG. 1A), while the operations of FIG. 4B may be performed by a consumer device that is not communicatively coupled to one of the payment nodes of the payments network (for example, the consumer device 101 and/or the payments device 105 of FIG. 1A). Referring to FIG. 2, at block 200, a message including a consumer-defined transaction amount for an electronic transaction with a merchant terminal is received at a computer server. The message may further include additional consumer-defined transaction parameters to which the transaction with the merchant terminal may be subject, for example, particular geographic locations, particular merchants, and/or durations/times of use. The server and the merchant terminal are communicatively coupled to respective payment nodes of a secure payments network, while the message is received via a network node that is outside of the payments network, for example, from a consumer device.

In response to receiving the message including the consumer-defined transaction amount (and/or other consumer-defined transaction parameters), an authorization response message for the electronic transaction with the merchant terminal is generated and transmitted from the server via a node of the payments network at block 240. The authorization response message may indicate authorization for the transaction with the merchant terminal, subject to the exact consumer-defined transaction amount (and/or other consumer-defined transaction parameter(s)) and independent of indication of other transaction parameters that may be defined or specified by the merchant terminal. As such, the authorization response message is generated and transmitted to control a transaction within the nodes of the payments network, responsive to a consumer-defined transaction amount that was received via a network node that is outside of the payments network.

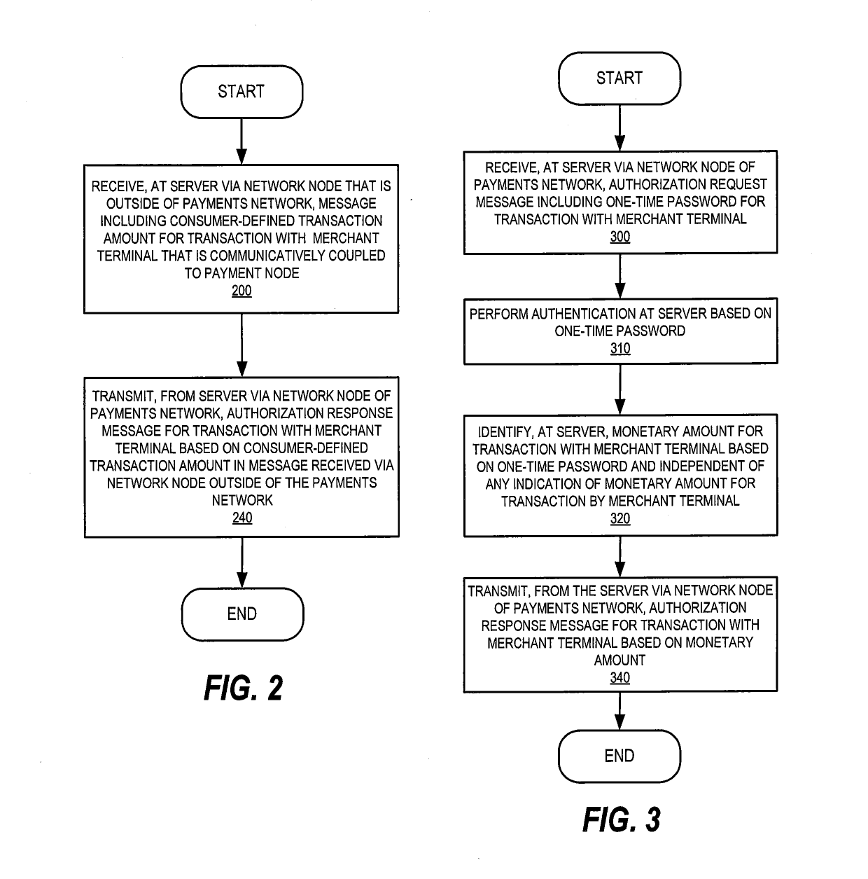

FIG. 3 is a flowchart illustrating further operations that may be performed by a computer server coupled to a payment node of a payments network, such as the authorization server 125 and/or the issuer server 120 of FIG. 1A, according to some embodiments. Referring now to FIG. 3, at block 300, an authorization request message for an electronic transaction with a merchant terminal is received at a computer server via a network node of a payments network to which the server and the merchant terminal are communicatively coupled. The authorization request message includes a one-time password that is provided by the merchant terminal, for example, in a transaction cryptogram. At block 310, authentication is performed at the server based on the one-time password. A monetary amount (or other transaction parameter) for the electronic transaction with the merchant terminal is identified by the server based on the one-time password at block 320. The monetary amount (or other transaction parameter) is identified by the server independent of any indication of the monetary amount (or other transaction parameter) by the merchant terminal, for instance, in transaction data or other data received from the merchant terminal. For example, in some embodiments, data received from the merchant terminal may not contain any indication of a monetary amount, that is, the monetary amount for the transaction may not be specified by the merchant terminal. In other embodiments, the data received from the merchant terminal may specify a merchant-defined transaction amount, but the server may identify a different monetary amount for the transaction from the one-time password. At block 340, an authorization response message is generated by the server and transmitted toward the merchant terminal via a network node of the payments network, for the specific monetary amount that was identified at block 320. For example, the monetary amount identified at block 320 may be a consumer-defined amount that was previously received from a consumer device via a network node that is outside of the payments network, and was previously associated with the one-time password by the server.

FIG. 4A is a flowchart illustrating operations for generation of a one-time password by a computer server coupled to a payment node of a payments network (for example, by the authorization server 125 and/or the issuer server 120 of FIG. 1A) according to some embodiments. Referring now to FIG. 4A, at block 410A, a password request message including a consumer-defined transaction amount for an electronic transaction is received at the server from a consumer device, via a network node that is outside of the payments network. The consumer device may be a wired or wireless communications terminal, which may be executing a web-based or client application program for communication with an issuer of an account, either directly (via an issuer-owned server) or indirectly (via a third-party authorization server). In response to receiving the password request message from the consumer device, a one-time password is generated by the server at block 430. The one-time password may be generated such that it is associated with the consumer-defined transaction amount included in the password request message, for example, by creation and storage of a corresponding data structure in a database that is accessible to the server, such as the OTP/amount database 135 of FIG. 1A.

Still referring to FIG. 4A, at block 450, a password response message including the one-time password is generated by and transmitted from the server to a device indicated by the password request message, via a network node outside of the payments network. For example, the server may transmit the one-time password to the consumer device from which the password request message was received, or other party's device with whom the user of the consumer device (for example, the account holder) wishes to share the one-time password to limit their use of the account. Also, although primarily described in FIG. 4A with reference to generating a one-time password that is associated with a consumer-defined monetary amount, it will be understood that the one-time password may be one of multiple consumer-defined transaction parameters included in the password request message, and that the one-time password may be generated such that it is associated with such multiple consumer-defined transaction parameters.

FIG. 4B is a flowchart illustrating operations that may be performed by a consumer device (such as the consumer device 101 and/or the payments device 105 of FIG. 1A) to initiate generation of the one-time password according to some embodiments. Referring now to FIG. 4B, a consumer-defined transaction amount for a transaction with a merchant terminal is received via a user interface of the consumer device at block 400. For example, in some embodiments, a user of the consumer device (for example, an account holder) may login to a web portal linked to the issuer, may select his or her account by providing an account identification number or other account identifier, and may enter a desired amount to which an electronic transaction with a merchant terminal is to be limited. In other embodiments, the user of the consumer device may download a client application (or “app”) provided by the issuer and associated with his or her account, and may enter the user's account identification number and desired transaction amount via the app. In some embodiments, the user may also specify additional transaction limitations (for example, particular geographic locations, particular merchants, and/or particular durations/times of use) via the user interface of the consumer device.

In response to the input received via the user interface at block 400, a password request message including the consumer-defined transaction amount (and/or other consumer-defined transaction parameters) is generated at the consumer device at block 405. At block 410B, the password request message is transmitted from the consumer device to a computer server. The server is communicatively coupled to the merchant terminal via one or more payment nodes of a secure payments network, such as the server 120/125. However, as the consumer device lacks access to the secure payments network, the password request message is transmitted to the server at block 410B via a network node that is outside of the payments network. As such, a consumer device that is not configured to access the payments network may exercise control over an electronic transaction with the merchant that is conducted over the payments network.

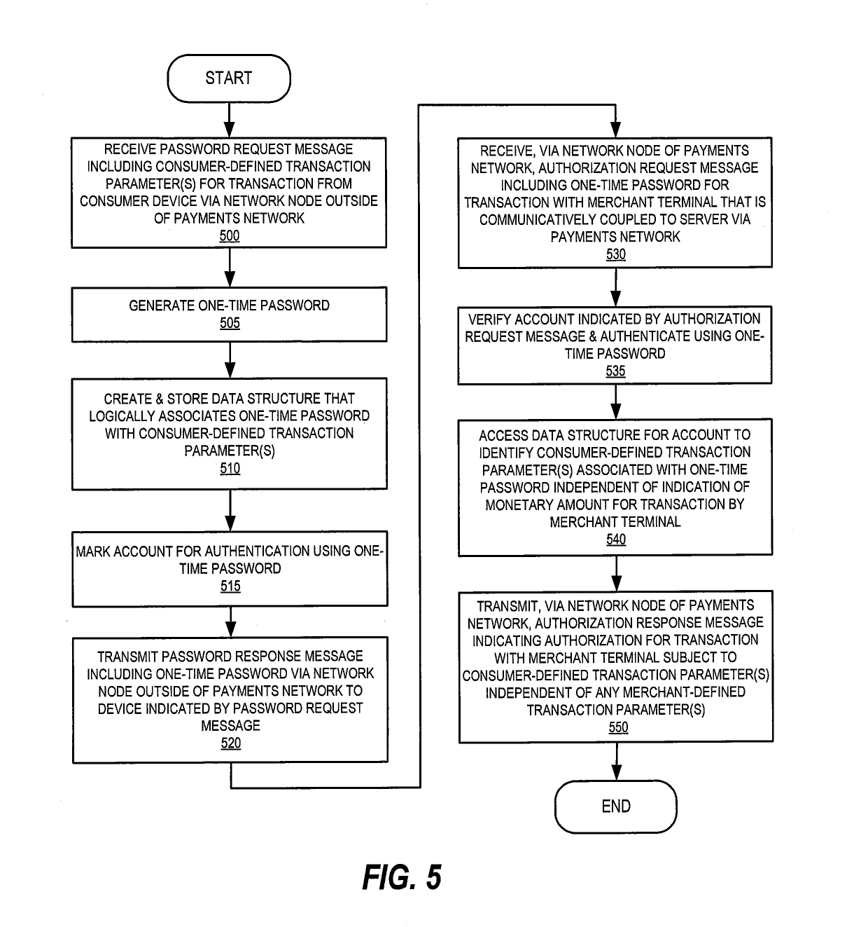

FIG. 5 is a flowchart illustrating operations that may be performed by a computer server (such as the authorization server 125 and/or the issuer server 120 of FIG. 1A) in generating, authenticating, and authorizing a one-time password based transaction in accordance with some embodiments described herein. Referring now to FIG. 5, a password request message including one or more consumer-defined transaction parameters is received from a consumer device at block 500. The consumer-defined transaction parameters may include, but are not limited to, a particular monetary amount, a particular merchant or merchants, a particular geographic location or locations, and/or a particular duration/time of use. The password request message also identifies an account for an electronic transaction, and includes a primary password that is associated with the account. The password request message is received from the consumer device via a network node that is outside of (e.g., unauthorized for communication with) a secure payments network.

In response to receiving the password request message, a one-time password or PIN (OTP; generally referred to as a one-time password) is generated at block 505, and a data structure that logically associates the one-time password with the consumer-defined transaction parameter(s) is created and stored in a database that is accessible to the server at block 510. In addition, in response to receiving the password request message, the account is authenticated based on the primary password included therein, and the account is marked for authentication using the one-time password (in addition to or instead of the primary password) at block 515. A password response message including the one-time password is thus generated and transmitted to a device indicated by the password request message at block 520. For instance, the password request message may specify that the one-time password is to be sent to the consumer device from which the password request message was received at block 500, and/or to another electronic device with whom the holder of the account for the electronic transaction wishes to share the one-time password. The password response message is transmitted to the specified device via a network node outside of the payments network at block 520. However, the password response message including the one-time password may also be sent to one of the payment nodes within the payment network and/or to an electronic device associated therewith. In either example, by transmitting the one-time password to another device at block 520, the account holder may avoid disclosing the primary password for the account to a merchant and/or other party.

Subsequent to the operations of blocks 500-520, an electronic transaction authorization request message including the one-time password is received via a network node of the payments network at block 530. For instance, the one-time password may be included in the authorization request message responsive to receipt of the one-time password from a merchant terminal that is communicatively coupled to one of the payment nodes of the payments network. The authorization request message further identifies the account for the electronic transaction, which is verified and authenticated using the one-time password at block 535. As the account was previously marked for authentication based on the one-time password, the authentication for the transaction may be performed at block 535 solely based on the one-time password, without receiving the primary password via the payments network (that is, independent of receiving the primary password). Responsive to the verification and authentication, the data structure (which was created at block 510) is accessed to identify the consumer-defined transaction parameter(s) associated with the one-time password at block 540. For example, the server may retrieve the data structure from a database accessible thereto to determine the consumer-defined transaction amount and/or other transaction parameter(s) to be applied to the transaction with the merchant terminal.

Still referring to FIG. 5, the transaction parameter(s) for the electronic transaction with the merchant terminal are identified at block 540 independent of other transaction parameters that may be specified in data received from the merchant terminal via one of the payment nodes of the payments network. As such, terms of a secure electronic transaction within the payments network are controlled by one or more consumer-defined transaction parameters received via network node(s) outside of the payments network, regardless or independent of any merchant-defined transaction parameters specified by the merchant terminal. An authorization response message indicating authorization for the electronic transaction with the merchant terminal is thus generated and transmitted towards the merchant terminal via a node of the payments network at block 550, for the particular monetary amount (and/or other transaction parameters) defined in the password request message received from the consumer device outside of the payments network, and independent of any conflicting transaction parameters defined by the merchant terminal.

Embodiments described herein may provide several advantages. For example, embodiments described herein may offer increased user convenience, as neither the user nor the merchant is required to enter the transaction amount (or other previously-defined transaction parameters) during the transaction at an ATM, POS, or other merchant terminal. That is, because the transaction amount (and/or other transaction parameters) can be pre-set by the account holder prior to the transaction, the amount of time required to perform an electronic transaction may be reduced. For instance, as noted above, OTP-based transactions described herein may allow for faster check-out at an ATM. Moreover, embodiments described herein may provide enhanced security, as only the previously-set amount can be withdrawn from/charged to the account, and as the PIN is valid for one use only. Thus, a merchant with whom the account number and OTP is shared cannot make subsequent withdrawals from the account (as the primary password/PIN is not shared with the merchant, and the OTP is valid only once). Likewise, a user/account holder may allow one or more other parties borrow his bank/credit/debit card for one time use, and only for an amount that he has previously entered, without communicating or otherwise sharing the primary password or PIN for the account.

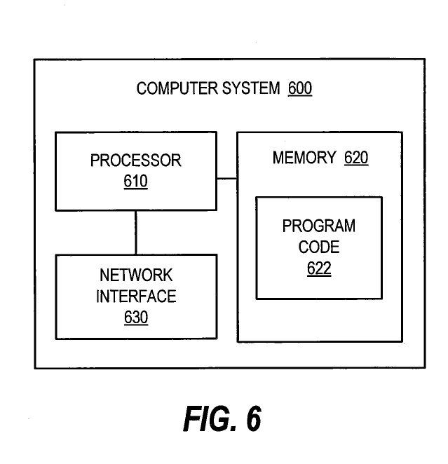

FIG. 6 is a block diagram of a computer system 600 that may be used as an authorization server/node 125, issuer server/node 120, consumer device 101, payments device 105, merchant terminal/node 111, and/or other computer hardware to perform the operations of one of more of the embodiments disclosed herein for one or more of those elements. The computer system 600 can include one or more network interface circuits 630, one or more processor circuits 610 (referred to as “processor” for brevity), and one or more memory circuits 620 (referred to as “memory” for brevity) containing computer-readable program code 622.

The processor 610 may include one or more data processing circuits, such as a general purpose and/or special purpose processor (e.g., microprocessor and/or digital signal processor) that may be collocated or distributed across one or more networks. The processor 610 is configured to execute program code 622 in the memory 620, described below as a computer readable storage medium, to perform some or all of the operations for one or more of the embodiments disclosed herein.

When the computer system 600 is configured as a consumer device 101 or payments device 105, the network interface 630 includes one or more radio transceivers configured to communicate with wireless devices (such as merchant terminal 111) using one or more radio access technologies. The radio access technologies may include, but are not limited to, Near Field Communication (NFC), Bluetooth, WLAN (IEEE 802.11), 3GPP Long Term Evolution (LTE), etc.

When configured as a consumer device 101 or payments device 105, the computer system 600 described herein may be provisioned with account parameters to enable the device to conduct transactions with respect to the account. Account parameters (also referred to as “account credentials”) are information relating to an account (e.g., a financial account, bank account, payment account, etc.) associated with a user that can be used to conduct transactions on the user's account (e.g., by placing the device in proximity to a contactless reader of an access device such as a point-of-sale (POS) terminal). Account parameters may include a semi-static set of data and a dynamic set of data, and some of the account parameters may be limited-use account parameters. The semi-static set of data may include an identifier that can be used to identify the account associated with the device (e.g., an account identifier such as a primary account number (PAN), an alternate account identifier such as a secondary PAN, or a token that is a substitute for an account identifier, etc.), an expiry date, and/or other account details or data that does not necessarily change for an extended period of time, or in some embodiments, for the lifetime of the account. The dynamic set of data may include one or more keys, information associated with the one or more keys, and/or other dynamic data that has a limited lifespan and is repeatedly refreshed or replenished during the lifetime of an account. The dynamic set of data can be used for or can relate to on-device generation of dynamic transaction cryptograms, or can represent dynamic transaction data during payment transactions. The dynamic set of data may be limited-use in the sense that the dynamic set of data can be used for only a limited time or a limited number of transactions, and may need to be renewed, refreshed, updated, or replenished when the dynamic set of data has exhausted its limited usage. For example, the dynamic set of data may include a limited-use key (LUK) that is used as an encryption key to generate a transaction cryptogram during a transaction.

### FURTHER DEFINITIONS AND EMBODIMENTS

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention, Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A computer server, comprising:
a network interface;
a processor coupled to the network interface; and
a memory coupled to the processor, the memory comprising a computer-readable storage medium storing computer-readable program code therein that, when executed by the processor, causes the processor to perform operations comprising:
receiving, through the network interface via a network node that is outside of a secure authorization network comprising a plurality of nodes, a message comprising a user-defined transaction parameter for transaction with a terminal that is communicatively coupled to one of the nodes;
receiving, through the network interface via the secure authorization network, an authorization request message for the transaction with the terminal, wherein the authorization request message comprises a one-time password that is provided by the terminal;
performing authentication based on the one-time password;
identifying the user-defined transaction parameter for the transaction with the terminal based on the one-time password included in the authorization request message; and
transmitting, through the network interface via the secure authorization network, an authorization response message for the transaction with the terminal based on the user-defined transaction parameter included in the message that was received via the network node that is outside of the authorization network.

2. The computer server of claim 1, wherein the secure authorization network comprises a payments network, the user-defined transaction parameter comprises a consumer-defined transaction amount, and the terminal comprises a merchant terminal, and wherein the transmitting comprises transmitting, through the network interface via the payments network, the authorization response message for the electronic transaction with the merchant terminal for the consumer-defined transaction amount independent of an indication of a monetary amount for the electronic transaction by the merchant terminal.

3. The computer server of claim 2, wherein the authorization request message further comprises transaction data identifying an account for the electronic transaction with the merchant terminal and does not contain the indication of the monetary amount for the electronic transaction by the merchant terminal.

4. The computer server of claim 2, wherein the message comprising the consumer-defined transaction amount comprises a password request message from a consumer device, and wherein, prior to receipt of the authorization request message for the electronic transaction with the merchant terminal, the computer-readable program code, when executed by the processor, further causes the processor to perform operations comprising:
generating the one-time password responsive to receiving the password request message from the consumer device such that the one-time password is associated with the consumer-defined transaction amount; and
transmitting, through the network interface via the network node that is outside of the payments network, a password response message comprising the one-time password to a device identified based on content of the password request message.

5. The computer server of claim 4, wherein the authorization request message further comprises transaction data indicating a merchant-defined transaction amount that is different from the consumer-defined transaction amount associated with the one-time password, and wherein the authorization response message indicates authorization for the electronic transaction with the merchant terminal for the consumer-defined transaction amount associated with the one-time password independent of the merchant-defined transaction amount.

6. The computer server of claim 2, wherein the computer server comprises an authorization server that receives the authorization request message and transmits, through the network interface via the payments network, the authorization response message to an issuer of an account for the electronic transaction with the merchant terminal.

7. A method, comprising:
performing operations as follows by a processor of a computer server that is communicatively coupled to one of a plurality of payment nodes of a payments network:
receiving, by the computer server via a network node that is outside of the payments network, a message comprising a consumer-defined transaction amount for an electronic transaction with a merchant terminal that is communicatively coupled to one of the payment nodes;
receiving, by the computer server via the payments network, an authorization request message for the electronic transaction with the merchant terminal, wherein the authorization request message comprises a one-time password that is provided by the merchant terminal;
performing, by the computer server, authentication based on the one-time password;
identifying, by the computer server, the consumer-defined transaction amount for the electronic transaction with the merchant terminal based on the one-time password included in the authorization request message; and
transmitting, from the computer server via the payments network, an authorization response message for the electronic transaction with the merchant terminal based on the consumer-defined transaction amount included in the message that was received via the network node that is outside of the payments network.

8. The method of claim 7, wherein the transmitting comprises transmitting, from the computer server via the payments network, the authorization response message for the electronic transaction with the merchant terminal for the consumer-defined transaction amount independent of an indication of a monetary amount for the electronic transaction by the merchant terminal.

9. The method of claim 8, wherein the authorization request message further comprises transaction data identifying an account for the electronic transaction with the merchant terminal and does not contain the indication of the monetary amount for the electronic transaction by the merchant terminal.

10. The method of claim 8, wherein the message comprising the consumer-defined transaction amount comprises a password request message from a consumer device, and further comprising the following prior to receiving the authorization request message for the electronic transaction with the merchant terminal:
generating, by the computer server, the one-time password responsive to receiving the password request message from the consumer device such that the one-time password is associated with the consumer-defined transaction amount; and
transmitting, from the computer server via the network node that is outside of the payments network, a password response message comprising the one-time password to a device identified based on content of the password request message.

11. The method of claim 10, further comprising:
creating a data structure that logically associates the one-time password with the consumer-defined transaction amount in the password request message that was received from the consumer device via the network node outside of the payments network; and
storing the data structure in a database that is accessible to the computer server,
wherein the identifying comprises accessing the data structure in the database responsive to receiving the authorization request message comprising the one-time password to determine the consumer-defined transaction amount.

12. The method of claim 10, wherein the password request message from the consumer device identifies an account for the electronic transaction and includes a primary password associated with the primary account, and further comprising:
marking the account for authentication by the one-time password responsive to receiving the password request message comprising the primary password from the consumer device via the network node that is outside of the payments network,
wherein the performing the authentication comprises authenticating the account based on the one-time password responsive to receiving the authorization request message and independent of the primary password.

13. The method of claim 12, wherein the one-time password comprises one of a plurality of secondary passwords associated with the account, and wherein each of the plurality of secondary passwords is associated with a respective consumer-defined transaction amount by a respective data structure stored in the database.

14. The method of claim 10, wherein the consumer-defined transaction amount comprises one of a plurality of consumer-defined transaction parameters included in the password request message, wherein generating the one-time password comprises associating the one-time password with the consumer-defined transaction parameters, and wherein the authorization response message indicates authorization for the electronic transaction with the merchant terminal subject to the consumer-defined transaction parameters.

15. The method of claim 10, wherein the authorization request message further comprises transaction data indicating a merchant-defined transaction amount that is different from the consumer-defined transaction amount associated with the one-time password, and wherein the authorization response message indicates authorization for the electronic transaction with the merchant terminal for the consumer-defined transaction amount associated with the one-time password independent of the merchant-defined transaction amount.

16. A computer program product, comprising:
a computer-readable storage medium having computer-readable program code embodied therein that, when executed by a processor of a computer server, causes the processor to perform operations comprising:
receiving, by the computer server via a network node that is outside of a payments network comprising a plurality of payment nodes, a message comprising a consumer-defined transaction amount for an electronic transaction with a merchant terminal that is communicatively coupled to one of the payment nodes;
receiving, by the computer server via the payments network, an authorization request message for the electronic transaction with the merchant terminal, wherein the authorization request message comprises a one-time password that is provided by the merchant terminal;
performing, by the computer server, authentication based on the one-time password;
identifying, by the computer server, the consumer-defined transaction amount for the electronic transaction with the merchant terminal based on the one-time password included in the authorization request message; and
transmitting, from the computer server via the payments network, an authorization response message for the electronic transaction with the merchant terminal based on the consumer-defined transaction amount included in the message that was received via the network node that is outside of the payments network.

17. The computer program product of claim 16, wherein the transmitting comprises transmitting, from the computer server via the payments network, the authorization response message for the electronic transaction with the merchant terminal for the consumer-defined transaction amount independent of an indication of a monetary amount for the electronic transaction by the merchant terminal.

18. The computer program product of claim 17, wherein the authorization request message further comprises transaction data identifying a primary account for the electronic transaction with the merchant terminal and does not contain the indication of the monetary amount for the electronic transaction by the merchant terminal.

19. The computer program product of claim 17, wherein the message comprising the consumer-defined transaction amount comprises a password request message from a consumer device, and wherein, prior to receipt of the authorization request message for the electronic transaction with the merchant terminal, the computer-readable program code, when executed by the processor, further causes the processor to perform operations comprising:
generating, by the computer server, the one-time password responsive to receiving the password request message from the consumer device such that the one-time password is associated with the consumer-defined transaction amount; and
transmitting, from the computer server via the network node that is outside of the payments network, a password response message comprising the one-time password to a device identified based on content of the password request message.

20. The computer program product of claim 17, wherein the authorization request message further comprises transaction data indicating a merchant-defined transaction amount that is different from the consumer-defined transaction amount associated with the one-time password, and wherein the authorization response message indicates authorization for the electronic transaction with the merchant terminal for the consumer-defined transaction amount associated with the one-time password independent of the merchant-defined transaction amount.
